(19) United States
(12) Patent Application Publication
(10) Pub. No.: US 2012/0171776 A1
(43) Pub. Date: Jul. 5, 2012

(54) METHOD FOR DETECTING AN ANALYTE

(75) Inventors: Narayanaswamy Jayaraman, Bangalore (IN); Govindasamy Jayamurugan, Bangalore (IN); Yamajala Bhaskara Rama Dur Rajesh, Bangalore (IN); Bagul Rahul Suresh, Bangalore (IN); Ajay Kumar Sood, Bangalore (IN)

(73) Assignee: INDIAN INSTITUTE OF SCIENCE, Bangalore, Karnataka (IN)

(21) Appl. No.: 13/395,345

(22) PCT Filed: Sep. 10, 2010
(86) PCT No.: PCT/IB10/54096

§ 371 Date: Mar. 9, 2012

(30) Foreign Application Priority Data
Sep. 11, 2009 (IN) 02206/CHE/2009

(51) Int. Cl. G01N 21/76; G01N 21/64

(52) U.S. Cl. 436/172; 422/82.08

(57) ABSTRACT

The disclosure relates to a method of detecting analytes using non-aromatic dendritic macromolecules. The inherent photoluminescence of dendrimers are utilized to detect analytes which are electron deficient in nature.

### TECHNICAL FIELD

The present disclosure relates to detection of analytes. In particular, the instant disclosure relates to detection of analytes by the use of fluorescence from dendrimers.

### BACKGROUND

Detection of analytes has enormous practical significance. The requirement of analyte detection assumes immense importance when the analyte exhibit detrimental effects. Analytes of particular importance are the aromatic molecules that are electron-deficient. Such electron deficient compounds generally have functional groups that are electron withdrawing, thereby leading to overall electron deficiency of the molecule. Electron-deficient aromatic molecules exhibit different redox potentials and depending on the extent of redox potential values, the molecules may exhibit instabilities due to external parameters, such as, pressures, temperatures. When the aromatic molecules are sensitive to these external factors, the importance to their detection becomes significant. Instabilities of analytes necessarily warranted developments of methods to detect their presence in all forms, namely, solid, solution and vapor phases. Methods as disparate as chromatography, mass spectrometry, spectroscopies, biological and electrochemical assays, or even real-time sensing by olfactory systems of canines were applied to identify the presence of such electron deficient analytes. Each method offered an advantage, in terms of the features of the technique itself, yet limitations due to factors such as limits of detection, cost and logistics of operation demand that techniques that can overcome some of the above barriers are constantly sought after.

Presence of a nitro- or a carbonyl group on the aromatic systems is examples of electron withdrawing group that lead to the aromatic system to be electron-deficient. Multiple nitro-group containing aromatic systems represent an extreme of such electron-deficient nature of aromatic molecules. These multiple nitro-group substituted benzene compounds have higher redox potentials, when compared to nitro-group substituted phenolic compounds. These attributes are reflected in a way in the high sensitivities of electron deficient aromatic compounds to pressures, temperatures and other environmental factors. Among methods to detect these analytes, spectroscopic method finds popularity, as a result of high sensitivities of the method, ease of operation. The method itself is aided by induced chemical interactions between the analyte and a host material with defined chemical constitution. The host materials are typically polymers incorporated with electron-rich aromatic moieties. Host-guest complexations are initiated as a result of complementary interactions between the host and guest, thereby leading to changes in the spectroscopic signatures of the host. Spectroscopic signature of interest in analyte detections is the one originating from emission of light, namely, fluorescence. Emission of light by a compound is the result of its excitation, using a different wavelength of light, i.e. excitation wavelength. Further, in order for a molecule to be excited, conventional requirement is that the molecules be either chromophores or fluorophores, so as to absorb or emit light. Conventional types of chromophore or fluorophores are the aromatic compounds capable to undergo excitation and emission, under appropriate conditions. Needless to mention, the chromophore or fluorophore behavior of aromatic molecule is identified before hand, and aromatic moieties with such utilitarian properties are incorporated in the polymers, in the effort to utilize the utilitarian property in analyte detections. Examples of aromatic group containing polymers with fluorophore property are disclosed. These reports pertain to detecting analytes through fluorescence changes. In these disclosures aromatic group containing polymers have high fluorescence properties, in addition to the ability to interact with analytes. Due to polymeric nature, the sensitivity of detection is high often, although a relation between the structure of the polymer and the associated sensing mechanisms are difficult to derive, due to undefined nature and polydispersities of the polymer. As a result, defining and fine-tuning structure-property relationship of polymeric sensing hosts is not possible.

The disclosure in this application describes a method to detect electron-deficient analytes using a recently evolved macromolecular type, namely dendrimers.

### STATEMENT OF DISCLOSURE

Accordingly the present disclosure provides a method for detecting an analyte comprising an act of measuring variation in photoluminescence of dendrimer in presence of the analyte; and a device for detecting an analyte, said device comprising dendrimer and spectrofluorimeter.

### BRIEF DESCRIPTION OF ACCOMPANYING DRAWINGS

The features of the present disclosure will become more fully apparent from the following description and appended claims, taken in conjunction with the accompanying drawings. Understanding that these drawings depict only several embodiments in accordance with the disclosure and are; therefore, not to be considered limiting of its scope, the disclosure will be described with additional specificity and detail through use of the accompanying drawings:

FIG. 1. Molecular structures of third and fourth generation PETIM dendrimers.

FIG. 2. Molecular structures of representative electron-deficient aromatic compound analytes.

FIG. 3. (a) and (b) Stern-Volmer plots of fluorescence intensity changes of G3-NH₂ in MeOH (0.5 mM) in the presence of various electron-deficient aromatic compounds (Q) (λₑₘ 390 nm; λₑₓ 330 nm).

FIG. 4. Relative fluorescence quenching efficiency of various electron-deficient aromatic compounds at chosen concentrations (3.72×10⁻⁶ M for nitrophenols and 1.15×10⁻³ M for other nitroanalytes) on G3-NH₂ (0.5 mM) dendrimer (λₑₘ 390).

FIG. 5. Time dependent emission spectra of a thin film of G4-NH₂ upon exposure to CDNB and NT vapor (25° C.) at defined time intervals 1, 5, 10, 15, 20, 25, 30, 35, 40, 45 min.

FIG. 6. Quenching and recovery of emission spectra of a thin film of G4-NH₂ upon exposure to NT vapor (25° C.), followed by treatment of the film with diethyl ether. R1-R4 represents recovery of fluorescence after one (NT1) to four (NT4) cycles of quenching due to exposure to NT vapor.

### DETAILED DESCRIPTION OF DISCLOSURE

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be combined in a wide variety, all of which are explicitly contemplated and make part of this disclosure.

The present disclosure is in relation to a method for detecting an analyte comprising act of measuring variation of photoluminescence of dendrimer exposed to the analyte.

In an embodiment of the present disclosure, the analyte is chemical analyte.

In another embodiment of the present disclosure, the chemical analyte is electron-deficient in nature.

In still another embodiment of the present disclosure, the chemical analyte is in a form selected from a group comprising solid, liquid and gaseous forms.

In still another embodiment of the present disclosure, the dendrimer is non-aromatic dendrimer.

In still another embodiment of the present disclosure, the non-aromatic dendrimer is poly(propyl ether imine) dendrimer.

In still another embodiment of the present disclosure, the detection of the analyte is carried out at a temperature ranging from about 20° C. to about 100° C., preferably at about 25° C.

In still another embodiment of the present disclosure, the measured photoluminescence is quenched photoluminescence of the dendrimer.

The present disclosure is also in relation to a device for detecting an analyte, said device comprising

a) dendrimer; and

b) spectrofluorimeter.

In still another embodiment of the present disclosure, the spectrofluorimeter is used to detect the quenching of fluorescence of the dendrimer when contacted with the analyte.

In still another embodiment of the present disclosure, the dendrimer is non-aromatic dendrimer.

In yet another embodiment of the present disclosure, the non-aromatic dendrimer is poly(propyl ether imine).

In an embodiment of the present disclosure among several detection methods, fluorescence-based method gained importance and popularity as a result of their high sensitivities and ability to detect a broad range of organic and inorganic analytes. In order for the detection to be purposeful, interaction between the analyte and sensor is required to be specific, thereby intervening the fluorophore properties of either the analyte or sensor. Due to the versatility of fluorescence-based detections, a large number of organic and inorganic fluorophores were identified, in order to be applicable to interface in many different chemical, biological and materials studies and applications. Chemical sensors constituted with fluorescent organic or inorganic moieties provide a response to an analyte interaction. Alternatively, a fluorescent tag or label is attached to the analyte or sensor which permits detection of the binding event. Aromatic or polyaromatic compounds and metal ions are fluorophores of choice, and such fluorophores act as either labels or as molecular constituent of one of the interacting partners. Monitoring changes in the fluorescence behavior of sensors constituted with preponderant fluorophores, such as, conjugated polymers, aromatic compounds with extended conjugations, polysilanes and polymetalloles, is documented and such sensors are considered highly towards further development of real time optical sensors. An entirely new type of optical sensors are described here, wherein the inherent fluorescence emerging from a class of dendrimers, as an efficient probe for the detection of aromatic nitro-compounds. The detection of analytes, both in solution and vapor phases, is achieved through quenching of the inherent fluorescence arising from dendrimers. An assessment of Stern-Volmer constants provide an estimate of the extent of quenching by each nitro compound.

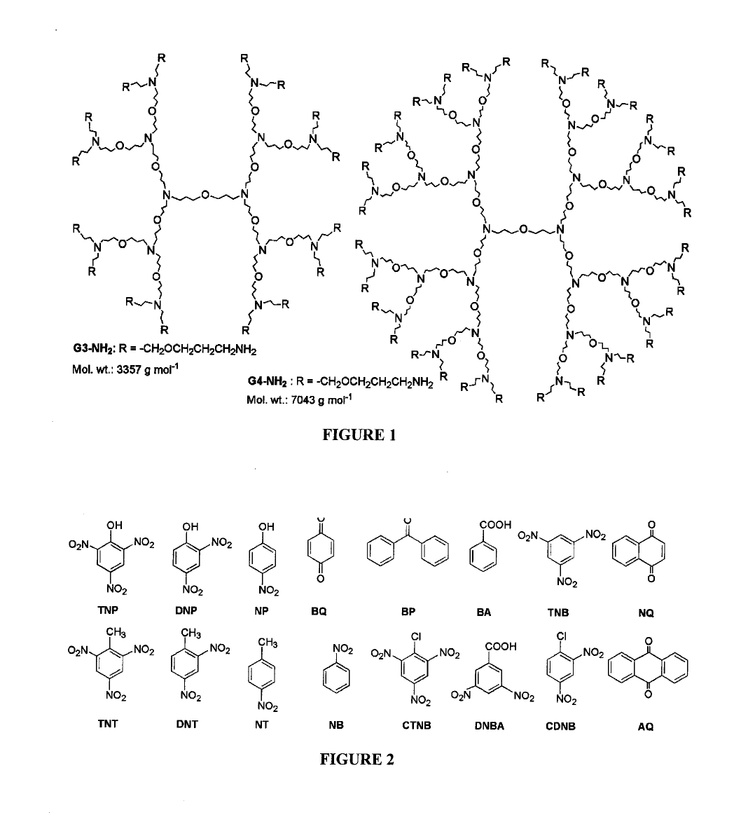

In an embodiment of the present disclosure dendritic macromolecules possess 100% branching through-out the structure and are often monodispersed, with nearly no polydispersity. Fully aliphatic constituent containing dendrimers reveal an interest, as the presence of utilitarian effects are not immediately obvious with these types of dendrimers, for example, their physico-chemical and biological behavior. Three important aliphatic dendrimers, namely, poly(propyl ether imine) (PETIM), poly(propylene imine) (PPI) and poly(amido amine) (PAMAM) dendrimers, are of particular interest. These three dendrimers present a common functionality, namely, a tertiary amine. The structures of PETIM dendrimers are depicted in FIG. 1. As a result of the presence of this functionality, these dendrimers show a fluorescence behavior when excited at a defined wavelength of light. Typically, the emission band for these dendrimers is spread in the region of 380-480 nm, when excited with a light in the region of 330-370 nm. The origin of unusual fluorescence in the above dendrimers is attributed to the presence of tertiary amines. Whereas PPI and PAMAM dendrimers exhibited the un-usual fluorescence and responded to aerial oxidations, the class of PETIM dendrimers exhibited an inherent fluorescence and the property was not affected by external factors, such as, exposure to air, moisture and temperature. These observations led to establish the novel phenomena of fluorescence in molecules that do not possess conventional chromophore or fluorophore. The intention of applying the observed un-usual fluorescence of aliphatic dendrimers was put-forth and studies were performed so as to identify the host-guest interactions with the above dendrimers, more particularly, with PETIM dendrimers. Series of studies establish that guest molecule interactions could be monitored facile through fluorescence behavior of these dendrimers. The fluorescence property was modified in the presence of guest molecules, whether in solution phase or vapor phase. This disclosure is based on the utility of inherent fluorescence of un-derivatized, native dendrimers to detect electron-deficient aromatic guest molecules.

In an embodiment of the present disclosure a recent entry to the class of fluorescent macromolecules is that of dendritic macromolecules, wherein the dendritic structural principles were exploited to study the behavior of fluorophores coupled to chosen dendritic structures. Such fluorophores were either aromatic moieties or luminescent metals incorporated at various sites within the dendritic structure. In addition to studies of dendrimers incorporated with known fluorophores, emergence of luminescence behavior from dendrimers not possessing conventional fluorophore or chromophore has been identified for a few dendrimer types, namely, poly(amido amine) (PAMAM), poly(propylene imine) (PPI) and poly(ether imine) (PETIM) dendrimers. This observation provided an opportunity to study the fluorescence emanating from molecules not possessing a classical fluorophore or chromophore. The presence of tertiary amine as the common functionality in the above dendrimer types appeared to cause the observed luminescence behavior. The presence of additional ether functionalities in PETIM dendrimers led to their observed inherent florescence behavior, a property to use as a probe of host-guest interaction. The host-guest properties of dendrimers are known in a number of cases, arising primarily from dynamic inner voids and the donor-acceptor properties of a chosen dendrimer. A guest molecule encapsulation might affect the inherent florescence behavior of a dendrimer. In the event when inherent fluorescence behavior of a dendrimer responds to host-guest interactions, the fluorescent property may obviate the requirement of the presence of an intentional fluorophore labeling, in order to monitor the interactions. The possibility of utilizing the inherent fluorescence property of PETIM dendrimers was undertaken with this objective. The complexation studies utilized electron-deficient aromatic compounds as guest molecules. Such aromatic compounds undergo facile electron donor-acceptor interactions and their electron-deficient property was beneficial in the development of novel electron-rich donor systems. The donor-acceptor interactions formed the basis to develop several polymers that detect electron deficient aromatic compounds. Electron-rich aromatic fluorophores were established as viable sensors for the detection of aromatic nitro-compounds. Electron donor-acceptor or charge-transfer interactions mediate complexation between the interacting partners which results in changes in the fluorophore properties. A first generation biphenyl-based dendron, having a trifluorene on the core has been studied for its ability to act as a sensor of aromatic nitro-compounds. As an important difference among the chromophores used so-far, the application herein identifies the inherent fluorescence of PETIM dendrimers as a useful probe to detect such compounds. Turn-off, namely, quenching, the dendrimer fluorescence occurs in the presence of electron-deficient aromatic compounds and the quenching is identified in both solution and solid state of the dendrimer. Studies across a range of electron-deficient aromatic compounds show that the fluorescence quenching of dendrimers is specific. Detection of aromatic compounds using inherent fluorescence property by an un-modified, native dendrimer is un-known currently.

In an embodiment of the present disclosure, Poly(propyl ether imine) (PETIM) dendrimers are constituted with tertiary amines, ether functionalities and propyl groups that connect ethers with tertiary amine branch points (FIG. 1). This dendrimer series show an inherent photoluminescence, even when they are devoid of classical aromatic fluorophores and unsaturated moieties. The photoluminescent non-aromatic dendrimers of generations 1 to 9 are stable in air, water, bases and common organic solvents, such as, hexanes, diethyl ether, tetrahydrofuran, methanol, ethyl acetate, 1,4-dioxane. These environmental and stability features of dendrimers permit their handling and storage conditions of dendrimers less stringent. Also exposure to above solvents and solutions do not interfere with detection of analytes. The fluorescence intensities of the non-aromatic dendrimers could be increased in the presence of acids. In addition to PETIM series of dendrimers, the non-aromatic, fluorescent dendrimers also includes poly(amido amine) and poly(propylene imine). The molecular structures of the various functional groups terminated third and fourth generation PETIM dendrimers are presented in FIG. 1. These structures are representative to the series of several generations of the PETIM dendrimers. The fluorescence behavior of these dendrimers is found to be inherent and is thought to arise from an ‘oxygen-nitrogen’ interaction moiety present within the dendritic structures. The fluorescence intensities of these dendrimers increased at acidic pH, on the other hand, anions, such as, nitrite and perchlorate quenched the fluorescence.

In an embodiment of the present disclosure, dendrimers embedded with lone pairs of electrons on multitude of oxygens and nitrogens were anticipated to interact with electron deficient aromatic compounds, and influence the fluorescence property of dendrimers. Third and fourth generation PETIM dendrimers, functionalized with amines (G3-NH₂ and G4-NH₂) at their peripheries were undertaken for the study (FIG. 1). The dendrimers exhibit an inherent fluorescence at 390 nm (λₑₓ 330) in MeOH solution and also as thin films. Life-time measurements showed that at least two species, with decay time constants of ˜2.08 ns and 7.31 ns, were responsible for the emission. Towards assessing the effect of aromatic compounds on the fluorescence behavior of dendrimers, a number of such compounds were chosen; a representative list is shown in FIG. 2. The studies were performed in solution (MeOH) and in vapor phases.

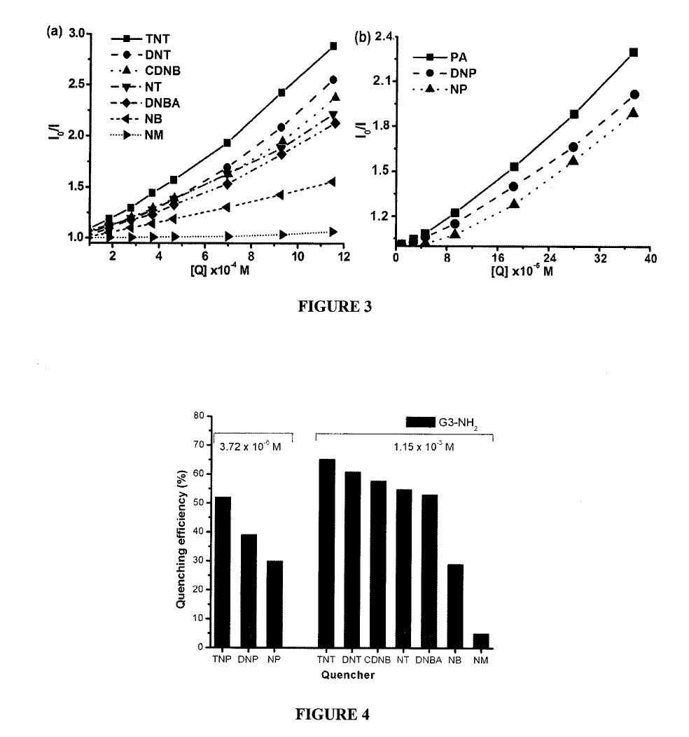

In an embodiment of the present disclosure differential changes in the emission intensities of dendrimers were followed upon addition of each analyte. FIG. 3 shows the effect of the addition of various aromatics on the fluorescence intensity of G3-NH₂, wherein a progressive decrease in the fluorescence intensity was observed generally. Relative quenching efficiency at a defined concentration of the analytes showed that increasing nitro-group within the molecule led to higher quenching (FIG. 4). Also, the quenching efficiencies were significantly higher for nitrophenols than that for nitrobenzenes. Further, higher generation G4-NH₂ dendrimer showed higher quenching efficiencies than G3-NH₂ dendrimer when solution concentrations remained same.

In an embodiment of the present disclosure, the relative quenching efficiencies of various electron-deficient aromatic compounds were calculated from steady-state Stern-Volmer plots. The Stern-Volmer equation, (I₀/I)−1=Kₛ₋ᵥ[Q], wherein I₀ is the initial fluorescence intensity of the dendrimer, I, the fluorescence intensity upon addition of analyte of concentration [Q] and K_{S-V} the Stern-Volmer constant, was used. The plot was fit to the linear part to quantify the quenching efficiencies.

In an embodiment of the present disclosure the measured fluorescence quenching efficiencies were found to be in the following order trinitrophenol>dinitrophenol>nitrophenol>>trinitrotoluene>dinitrotoluene>nitrotoluene>chlorodinitrobenzene>dinitrobenzoic acid>nitrobenzene>>nitromethane (Table 1). This trend correlated qualitatively with the reduction potential of each analyte, wherein an analyte with less negative reduction potential exhibited a higher quenching efficiency. Thus, TNP with approximately zero reduction potential showed the highest quenching effect in the series of compounds studied. The observed values were comparable with that known from reports concerned with polyiptycene⁴⁻⁶ and polymetallole³ based chemical sensors. Further, hydroxyl group functionalized dendrimers also underwent a similar effect of fluorescence quenching, thereby indicating that fluorescence quenching was not dependant on nature of peripheral functional groups.

TABLE 1
Redox potentials (E_{red}), vapor pressures and Stern-Volmer constants
(K_{S-V}) for the interaction of analytes with G3-NH₂ in MeOH

| | | Vapor | | |
|---|---|---|---|---|
| | | pressure | | |
| Analyte | E_{red} (V)^{[1]} | (mmHg)^{[2]} | K_{S-V} (mol⁻¹) | K_{S-V} mol⁻¹ |
| Trinitrophenol | ~0 | 7.5 × 10⁻⁷ | 17358 ± 1540 | 11000^{[3]} |
| Dinitrophenol | −0.13 | 1.42 × 10⁻⁵ | 14917 ± 1235 | |
| Nitrophenol | −0.16 | 4.1 × 10⁻⁵ | 10316 ± 958 | |
| Trinitrotoluene | −0.7 | 8.02 × 10⁻⁶ | 1530 ± 68 | |
| Dinitrotoluene | −0.9 | 1.74 × 10⁻⁴ | 1185 ± 56 | 4340^{[3]} |
| | | | | and |
| | | | | 1170^{[4],[5]} |
| Nitrotoluene | −1.2 | 1.64 × 10⁻¹ | 908 ± 38 | |
| Chloroninitro- | −0.8 | 8.49 × 10⁻⁵ | 916 ± 40 | 2420^{[3]} |
| benzoic acid | | | | |
| Dinitrobenzoic | −0.58 | 1.41 × 10⁻⁶ | 333 ± 21 | 1200^{[3]} |
| acid | | | | |
| Nitrobenzene | −1.15 | 2.7 × 10⁻¹ | 306 ± 36 | |
| Nitromethane | −1.06 | 3.58 × 10⁻¹ | 26 ± 1.7 | |

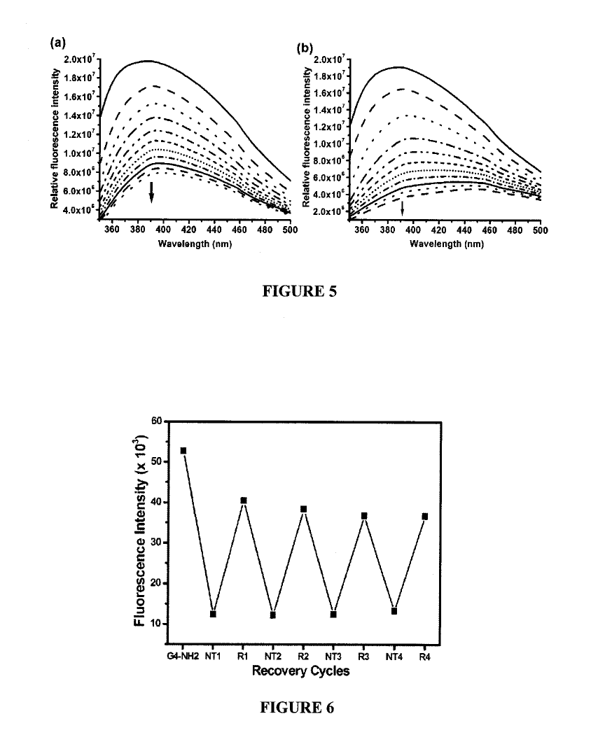

In an embodiment of the present disclosure, on establishing fluorescence quenching of dendrimers by electron-deficient aromatic compounds in solutions, studies were undertaken to assess fluorescence quenching abilities of analyte vapors. G4-NH₂ was chosen to study the effect of vapors of CDNB and NT. These compounds possess relatively higher vapor pressures in the series. A solution of G4-NH₂ in MeOH was drop-cast on a side wall of the quartz cuvette and dried thoroughly to obtain a thin film of the dendrimer. Following this, a single crystal of the analyte was kept at ˜3 cm distance and the fluorescence was measured at ambient temperature. A considerable reduction in the fluorescence intensity was observed within a minute and more than 80% quenching occurred in ˜45 min. in the case of analytes, such as, NT and ˜35% in the case of TNT (FIG. 5).

In an embodiment of the present disclosure, the dendrimer fluorescence regenerated when the electron-deficient aromatic compounds vapor impregnated dendrimer film was dipped to an diethyl ether solution for ˜2 min. The recovery and re-use of thin film exposed to nitrotoluene vapor is presented in FIG. 6. Nearly 80% of original dendrimer fluorescence was regained by this method. The regenerated film was exposed to analyte vapor, so as to identify its efficacy to interact with the analyte and the attendant fluorescence quenching. Quenching to the extent as in the case of the film in the first cycle was observed. The fluorescence quenching and regeneration remained observable for few cycles, thereby indicating a specific interaction between dendrimer and the analyte. Further, there was no shift in emission wavelength and the emission bandwidth was nearly same for solution and thin films, thereby ruling out possibilities of self-quenching occurring within the dendrimer films. Analyte vapors permeate through the dynamic inner cavities in the dendritic structure, leading to the formation of a host-guest complex, and the attendant fluorescence quenching. An important aspect of PETIM dendrimer fluorescence is their relative insensitivities to common interferents. Ageing and exposure of dendrimers to air, in both solutions and thin films, did not affect the fluorescence behavior, nor exposure of dendrimers to organic solvents, such as, benzene, toluene, tetrahydrofuran and methanol. Nitro-alkanes, such as, nitromethane, did not affect the fluorescence significantly. The slightly upward curvature of Stern-Volmer plots (FIG. 4) indicated a static quenching process, wherein a rapid electron transfer to the analyte occurred upon excitation of the dendrimer host. The response time of detection did not vary significantly, indicating a host-guest complexation rather than a non-specific adsorption process. p-Benzoquinone (E_{red}=−0.5 V and vapor pressure=0.9 mm) as an acceptor was also analyzed. The quenching constant (K_{S-V}) was found to be 7405 M⁻¹, thereby implying that electron deficient aromatic species is in general a good substrate for complexation to dendrimers, and the attendant changes in the fluorescence intensities.

In an embodiment of the present disclosure, the marked difference between dendrimers studied herein and the host of polymer systems known previously is the nature of fluorophore. Conjugated organic and inorganic polymers interact with nitroaromatic analytes through largely a π-π interaction. The disclosure herein demonstrates an alternate mode of interaction which allows the detection of electron-deficient aromatic analytes. We presume that an electron-deficient analyte forms a complex with electron-rich dendrimer through a donor-acceptor interaction which, in turn, disrupts fluorescent-active moiety, leading to the observed fluorescence quenching. PETIM dendrimers adopt a dense interior presenting a hydrophobic environment constituted by the propylene spacers of the dendrimer. This hydrophobic environment assists the encapsulation, in addition to donor-acceptor interactions, between lone pairs of electrons on multitude of oxygens and nitrogens, and the analytes. Thus, the physical and photochemical properties of PETIM dendrimers are amenable for not only electron-deficient guest interactions, but also their facile monitoring, through quenching of inherent fluorescence of the dendrimers.

In an embodiment of the present disclosure, the detection of analytes are carried out using a device comprising dendrimer and spectrofluorimeter. In the device the dendrimer and the spectrofluorimeter are used together to detect the quenching of fluorescence of the dendrimer when contacted with the analyte. The analyte can be in solid phase, solution phase or gaseous phase.

The disclosure is further elaborated with the help of following examples. However, these examples should not be construed to limit the scope of disclosure.

### EXAMPLE 1

### Solution Phase Fluorescence Quenching of Dendrimers with Analyte in the Solution Phase

Solution phase fluorescence quenching studies are performed using various generation PETIM dendrimers (FIG. 1) in spectroscopic-grade methanol (0.5 mM), at 25° C. The excitation and emission wavelengths were 330 and 390 nm, respectively. An aliquot of analyte in MeOH was mixed to a dendrimer solution and, after an equilibration for 2-3 min., the emission spectrum recorded.

### EXAMPLE 2

### Solid Phase Fluorescence Quenching of Dendrimers with Analyte in the Vapor Phase

Studies of the thin film quenching properties of fourth generation dendrimer were focused on chlorodinitrobenzene and nitrotoluene, as they provide rapid and large-amplitude responses that are convenient to monitor.

A solution of G4 dendrimer in methanol was drop-cast on the side wall of the quartz cuvette and air dried. The analyte (chlorodinitrobenzene, nitrotoluene) was placed in a vial and kept at ˜3 cm and at 25° C. for a period of time. Representative data of chlorodinitrobenzene and nitrotoluene are plotted in FIG. 5. Chlorodinitrobenzene and nitrotoluene quenched the dendrimer fluorescence in a same fashion.

An important aspect of the PETIM dendrimer fluorescence is their relative insensitivity to common interferents. Control experiments, including those aromatic compounds that do not have the nitro-group in their molecular structure, did not show any change in the photoluminescence spectrum, in both solutions and thin films of dendrimers. Similarly, exposure of dendrimers both as solutions and thin films to organic solvents such as toluene, tetrahydrofuran and methanol produced no change in the photoluminescence intensity.

The disclosure demonstrates the utility of inherent fluorescence of dendrimers as a photo-probe to detect electron-deficient aromatic compounds, both in solution and vapor phases. Utilizing inherent fluorescence property of dendrimers is helpful for the detection of electron-deficient analytes.

### REFERENCES

[1] L. Meites, P. Zuman, Handbook Series in Organic Electrochemistry, CRC Press: Boca Raton, Fla., vol 1., 1978
[2] P. H. Howard, W. M. Meylan, Handbook of Physical Properties of Organic Chemicals, CRC Press: Boca Raton, Fla., 1997.
[3] H. Sohn, M. J. Sailor, D. Magde, W. C. Trögler, J. Am. Chem. Soc. 125 (2003) 3821-3830.
[4] J.-S. Yang, T. M. Swager, J. Am. Chem. Soc. 120 (1998) 5321-5322.
[5] J.-S. Yang, T. M. Swager, J. Am. Chem. Soc. 120 (1998) 11864-11873.
[6] D. Zhao, T. M. Swager, Macromolecules 38 (2005) 9377-9384.

1. A method for detecting an analyte comprising an act of measuring variation in photoluminescence of a dendrimer in presence of the analyte.

2. The method as claimed in claim 1, wherein the analyte is chemical analyte.

3. The method as claimed in claim 2, wherein the chemical analyte is electron-deficient in nature.

4. The method as claimed in claim 2, wherein the chemical analyte is in a form selected from a group comprising solid, liquid and gaseous forms.

5. The method as claimed in claim 1, wherein the dendrimer is non-aromatic dendrimer.

6. The method as claimed in claim 1, wherein the non-aromatic dendrimer is poly(propyl ether imine) dendrimer.

7. The method as claimed in claim 1, wherein the detection of the analyte is carried out at a temperature ranging from about 20° C. to about 100° C., preferably at about 25° C.

8. The method as claimed in claim 1, wherein the measured photoluminescence is quenched photoluminescence of the dendrimer.

9. A device for detecting an analyte, said device comprising
c) dendrimer; and
d) spectrofluorimeter.

10. The device as claimed in claim 9, wherein the dendrimer and the spectrofluorimeter are used together to detect the quenching of fluorescence of the dendrimer when contacted with the analyte.

11. The device as claimed in claim 9, wherein the dendrimer is non-aromatic dendrimer.

12. The device as claimed in claim 11, wherein the non-aromatic dendrimer is poly(propyl ether imine) dendrimer.
